(19) United States
(12) Patent Application Publication
(10) Pub. No.: US 2023/0071134 A1
(43) Pub. Date: Mar. 9, 2023

(54) SERVER DEVICE AND ELECTRIC POWER TRANSACTION SYSTEM

(71) Applicant: TOYOTA JIDOSHA KABUSHIKI KAISHA, Toyota-shi (JP)

(72) Inventors: Hiromitsu KIGURE, Ashigarakami-gun (JP); Yuki KUDO, Susono-shi (JP); Kazutaka KIMURA, Mishima-shi (JP); Kazuki OBATA, Susono-shi (JP); Satoshi KIKUCHI, Hadano-shi (JP); Yuta MANIWA, Susono-shi (JP)

(73) Assignee: TOYOTA JIDOSHA KABUSHIKI KAISHA, Toyota-shi (JP)

(21) Appl. No.: 17/856,746

(22) Filed: Jul. 1, 2022

(30) Foreign Application Priority Data
Sep. 6, 2021 (JP) 2021-144556

(51) Int. Cl. G06Q 30/08; G06Q 20/40; G06Q 50/06; B60L 53/66

(52) U.S. Cl. CPC G06Q 30/08; B60L 53/665; G06Q 20/407; G06Q 50/06

(57) ABSTRACT

A server device includes a processor and a memory for storing a program executed by the processor. A plurality of units includes a first unit, a second unit, and a third unit. The processor accepts a bid of the second unit regarding a transaction for electric power transfer with the first unit, and executes a contract process for causing the third unit to perform the electric power transfer with the first unit, when the second unit does not perform the electric power transfer with the first unit at a scheduled time of the electric power transfer.

### CROSS-REFERENCE TO RELATED APPLICATION

This application claims priority to Japanese Patent Application No. 2021-144556 filed on Sep. 6, 2021, incorporated herein by reference in its entirety.

### BACKGROUND

### 1. Technical Field

The present disclosure relates to a server device and an electric power transaction system, and more specifically to a server device and an electric power transaction system for performing electric power transfer between a plurality of units.

### 2. Description of Related Art

Japanese Unexamined Patent Application Publication No. 2020-9334 (JP 2020-9334 A) discloses a system in which constituents such as a house and a company can perform a transaction for electric power transfer (hereinafter, also referred to as “electric power transaction”) via an electric power transaction platform.

### SUMMARY

According to the system disclosed in JP 2020-9334 A, the constituents can perform the transaction for the electric power transfer. However, in the system disclosed in JP 2020-9334 A, no consideration is given as to when the electric power transfer is not performed even though the transaction for the electric power transfer was scheduled, and there is room for improvement in the electric power transaction.

The present disclosure has been made to solve the above-mentioned issue, and the purpose of the present disclosure is to provide a technology capable of optimally performing the transaction for the electric power transfer without interrupting the transaction for the electric power transfer as much as possible.

A server device according to an aspect of the present disclosure is a server device that performs a transaction for electric power transfer between a plurality of units, and that includes a processor and a memory for storing a program executed by the processor. The units include a first unit, a second unit, and a third unit. The processor accepts a bid of the second unit regarding a transaction for electric power transfer with the first unit, and executes a contract process for causing the third unit to perform the electric power transfer with the first unit, when the second unit does not perform the electric power transfer with the first unit at a scheduled time of the electric power transfer.

According to the above configuration, after the bid regarding the transaction for the electric power transfer of the second unit with the first unit is accepted, even when the electric power transfer with the first unit is not performed by the second unit at the scheduled time of the electric power transfer, the third unit performs the electric power transfer with the first unit. As a result, the transaction for the electric power transfer can be optimally performed without interrupting the transaction for the electric power transfer between the units as much as possible.

The processor executes a penalty process for imposing a penalty on a user of the second unit, when the second unit does not perform the electric power transfer with the first unit at the scheduled time.

According to the above configuration, when the electric power transfer is not performed with the first unit at the scheduled time of the electric power transfer, a penalty is imposed on the user of the second unit. However, since the third unit, instead of the second unit, performs the electric power transfer with the first unit, it is possible to avoid imposing a penalty on the user of the second unit.

The processor determines the third unit from the units according to a priority based on a predetermined rule, when the second unit does not perform the electric power transfer with the first unit at the scheduled time of the electric power transfer.

According to the above configuration, when the electric power transfer with the first unit is not performed by the second unit at the scheduled time of the electric power transfer, the third unit is determined according to the priority based on the predetermined rules, so that the transaction for the electric power transfer can be optimally performed according to the priority.

The processor determines the priority before the scheduled time arrives.

According to the above configuration, since the priority for determining the third unit is determined before the scheduled time of the electric power transfer arrives, the transaction for the electric power transfer can be optimally performed according to the predetermined priority.

The processor determines, as the predetermined rule, the priority based on at least one of a transaction price of the electric power transfer, a bid order for the transaction of the electric power transfer, an electric power amount for the transaction of the electric power transfer, a past evaluation result for the transaction of the electric power transfer, and a distance from a location in which the electric power transfer is performed.

According to the above configuration, the transaction for the electric power transfer can be optimally performed according to the priority determined based on at least one of the transaction price of the electric power transfer, the bid order for the transaction of the electric power transfer, the electric power amount for the transaction of the electric power transfer, the past evaluation result for the transaction of the electric power transfer, and the distance from the location in which electric power transfer is performed.

The processor determines a unit that shares a right with the second unit as the third unit.

According to the above configuration, even when the electric power transfer with the first unit is not performed by the second unit at the scheduled time of the electric power transfer, the third unit sharing the right with the second unit performs the electric power transfer with the first unit, so that the transaction for the electric power transfer can be optimally performed.

The processor determines a unit selected by a user of the second unit as the third unit before the scheduled time arrives.

According to the above configuration, even when the electric power transfer with the first unit is not performed by the second unit at the scheduled time of the electric power transfer, the third unit that has been selected by the user of the second unit performs the electric power transfer with the first unit, so that the transaction for the electric power transfer can be optimally performed.

The processor executes the contract process when a user of the second unit cancels the electric power transfer with the first unit at the scheduled time.

According to the above configuration, even when the electric power transfer with the first unit is canceled by the user of the second unit at the scheduled time of the electric power transfer, the third unit performs the electric power transfer with the first unit, so that the transaction for the electric power transfer can be optimally performed.

An electric power transaction system according to an aspect of the present disclosure is an electric power transaction system that performs a transaction for electric power transfer, and that includes a plurality of units, each of which is able to perform the electric power transfer, and a server device. The units include a first unit, a second unit, and a third unit. The server device accepts a bid of the second unit regarding a transaction for electric power transfer with the first unit, and executes a contract process for causing the third unit to perform the electric power transfer with the first unit, when the second unit does not perform the electric power transfer with the first unit at a scheduled time of the electric power transfer.

According to the above configuration, after the bid regarding the transaction for the electric power transfer of the second unit with the first unit is accepted, even when the electric power transfer with the first unit is not performed by the second unit at the scheduled time of the electric power transfer, the third unit performs the electric power transfer with the first unit. As a result, the transaction for the electric power transfer can be optimally performed without interrupting the transaction for the electric power transfer between the units as much as possible.

According to the present disclosure, the transaction for the electric power transfer can be optimally performed without interrupting the transaction for the electric power transfer between the units as much as possible.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an electric power transaction system according to an embodiment;

FIG. 2 is a diagram illustrating an example of a P2P electric power transaction market to which the electric power transaction system according to the embodiment is applied;

FIG. 3 is a diagram illustrating an example of bidding in a general transaction market for P2P electric power transaction;

FIG. 4 is a diagram illustrating an example of bidding in a direct transaction market for P2P electric power transaction;

FIG. 5 is a diagram illustrating an example of a configuration of the electric power transaction system according to the embodiment;

FIG. 6 is a diagram illustrating an example of unit information stored in an agent device;

FIG. 7 is a diagram illustrating an example of agent information stored in a server device;

FIG. 8 is a diagram illustrating an example of priority information stored in the server device;

FIG. 9 is a diagram illustrating an example of an electric power transaction by the electric power transaction system;

FIG. 10 is a flowchart showing a process procedure at the time of bidding in the server device; and

FIG. 11 is a flowchart showing a process procedure at the time of the electric power transaction in the server device.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

### Outline of Electric Power Transaction System

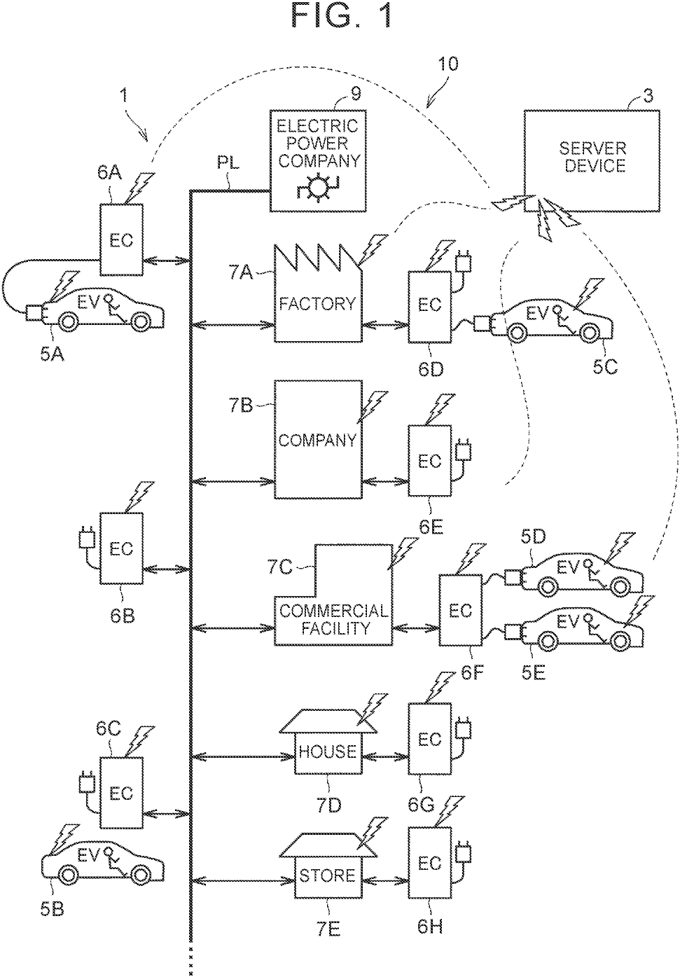

FIG. 1 is a diagram illustrating an example of an electric power transaction system 1 according to the embodiment. As shown in FIG. 1, the electric power transaction system 1 is configured to perform a transaction for electric power transfer between a plurality of units. Specifically, the electric power transaction system 1 includes a plurality of units, each of which can perform the electric power transfer, and a server device 3. The server device 3 is configured to be able to communicate with each of the units via a network 10. The “electric power transfer” is a concept including at least one of a first unit supplying electric power to a second unit and a first unit receiving electric power from the second unit.

The units include vehicles 5A to 5E and various buildings such as a factory 7A, a company 7B, a commercial facility 7C, a house 7D, and a store 7E. The vehicles 5A to 5E are electrified vehicles equipped with a battery for traveling, and include, for example, a battery electric vehicle (BEV) or a plug-in hybrid electric vehicle (PHEV). The units such as the vehicles 5A to 5E and the factory 7A are configured to be connectable to chargers/dischargers 6A to 6H. The chargers/dischargers 6A to 6H are connected to chargeable/dischargeable units such as the vehicles 5A to 5E to supply electric power to the connected units or receive electric power from the units. In the following, the vehicles 5A to 5E are also simply referred to as “vehicles”, and the chargers/dischargers 6A to 6H are also simply referred to as “chargers/dischargers”. Further, devices or facilities capable of performing the electric power transfer such as the vehicles 5A to 5E and the factory 7A are also simply referred to as “units”. The “units” may include the chargers/dischargers 6A to 6H.

The electric power from an electric power company 9 is supplied to various buildings such as the factory 7A, the company 7B, the commercial facility 7C, the house 7D, and the store 7E via an electric power transmission line network PL (electric power grid system). Due to the liberalization of electric power and the spread of electric power generation technology for renewable energy, peer to peer (P2P) electric power transaction can be introduced, in which electric power is bought and sold not only by the electric power company 9, but also bought and sold directly between an individual or a corporation having electric power resources and another individual or corporation that is a consumer of electric power.

For example, the vehicle enables charging and discharging of the battery by being connected to a charger/discharger installed in the electric power transmission line network PL or various buildings such as the factory 7A. That is, by being connected to the charger/discharger, the vehicle can directly perform the electric power transfer between the electric power company 9 via the electric power transmission line network PL, or can directly perform the electric power transfer between various buildings such as the factory 7A. In this way, the electric power transfer using a mobile body such as a vehicle can be performed by P2P transaction.

In the electric power transaction system 1, electric power consumers such as the vehicles, the factory 7A, and the house 7D access the market for P2P electric power transaction through communication with the server device 3 to bid for the purchase or sale of electric power. For example, when an electric power consumer wishes to buy or sell electric power, the electric power consumer makes a bid in the electric power transaction market in which the electric power consumer wishes to perform the electric power transaction via the server device 3, on bidding conditions such as the desired time zone for the purchase or sale of electric power, the electric power amount per unit time zone, and the transaction price. The operator of the P2P electric power transaction market uses a given algorithm to put into effect a contract for the electric power transaction between a seller and a buyer who agree with the bidding conditions, and processes as uncontracted for a bid for which no one who agrees with the conditions is found. Note that “bid” means the act of ordering the electric power transaction such as purchase or sale, or the order itself. On the other hand, “contract” means the act of determining to perform the electric power transaction that has been bidden, or the determination itself.

### Outline of P2P Electric Power Transaction Market

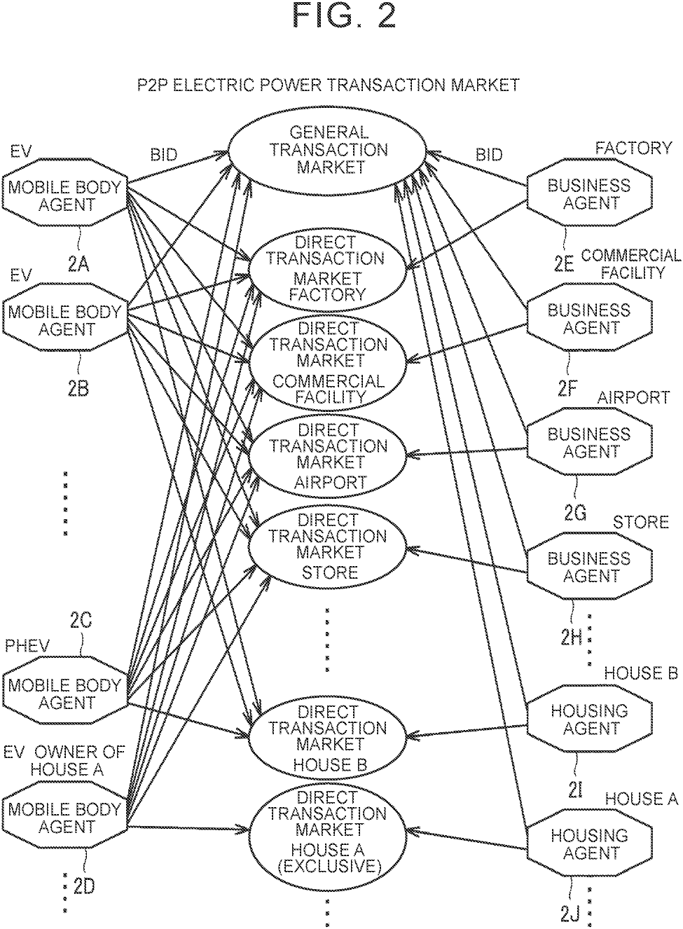

FIG. 2 is a diagram illustrating an example of the P2P electric power transaction market to which the electric power transaction system 1 according to the embodiment is applied. As shown in FIG. 2, the P2P electric power transaction market is provided with, for example, mobile body agents 2A to 2D that manage bids and contracts for mobile bodies such as vehicles, business agents 2E to 2H that manage bids and contracts for large electric power consumers with relatively large electric power demands such as factories, commercial facilities, airports, and stores, and housing agents 2I and 2J that manage bids and contracts for small electric power consumers with relatively small electric power demands such as houses. Each of the vehicle, larger electric power consumer, and small electric power consumer is configured to bid through the corresponding agent.

The P2P electric power transaction market includes a general transaction market and a direct transaction market (individual transaction market). The general transaction market is a market in which an unspecified number of agents can participate in electric power transactions. In the general transaction market, contracts are performed for electric power transactions according to a given rule set by the operator who organizes the P2P electric power transaction market. As a matching rule, there is a method of closing a transaction on a first-come-first-served basis when the price offered by the seller and the price offered by the buyer match in a unit time zone. Another matching rule is to sort out the bids (orders) of the sellers and the buyers that have been made in a unit time zone and then close the transaction at an appropriate price.

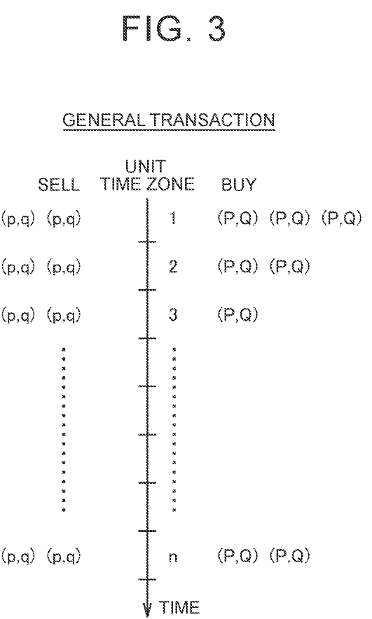

FIG. 3 is a diagram illustrating an example of bidding in the general transaction market for the P2P electric power transaction. As shown in FIG. 3, in the general transaction market, while an unspecified number of sellers bid for a combination of a price and an electric power amount (p, q), an unspecified number of buyers bid for a combination of a price and an electric power amount (P, Q), for each unit time zone (1, 2, ... n). The unit time zone is a time width (for example, 30 minutes) set in the general transaction market. The transaction of the electric power amount is performed for each electric power amount (electric power × unit time zone length) that is transmitted in the unit time zone.

The direct transaction market is a market in which only agents having the ID for the direct transaction market can participate in the electric power transactions. As shown in FIG. 2, in the direct transaction market, one market is configured for a fixed electric power consumer in which a charger/discharger is installed. The server device managed by each electric power consumer may constitute one direct transaction market, or one server device may constitute a plurality of direct transaction markets. In the direct transaction market, contracts are performed for electric power transactions according to a given rule uniquely set by the operator of each market. For example, as described above, the matching rule includes a method of closing a transaction on a first-come-first-served basis when the price offered by the seller and the price offered by the buyer match in a unit time zone, or sorting out the bids (orders) of the sellers and the buyers that have been made in a unit time zone and then closing the transaction at an appropriate price.

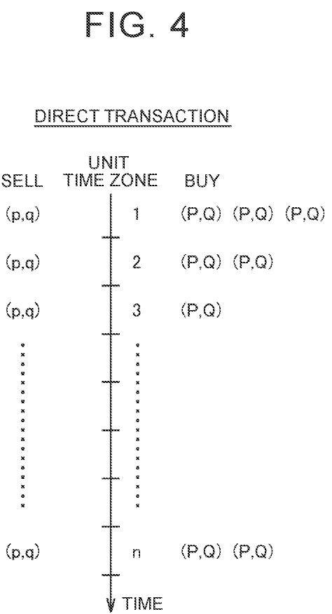

FIG. 4 is a diagram illustrating an example of bidding in the direct transaction market for the P2P electric power transaction. As shown in FIG. 4, in the direct transaction market, in response to the sellers presenting a combination of a price and an electric power amount (p, q), multiple buyers having the ID for the direct transaction market bid for a combination of a price and an electric power amount (P, Q), for each unit time zone (1, 2, ... n). The unit time zone is a time width (for example, 30 minutes) individually set in the direct transaction market. The transaction of the electric power amount is performed for each electric power amount (electric power × unit time zone length) that is transmitted in the unit time zone.

### Configuration of Electric Power Transaction System

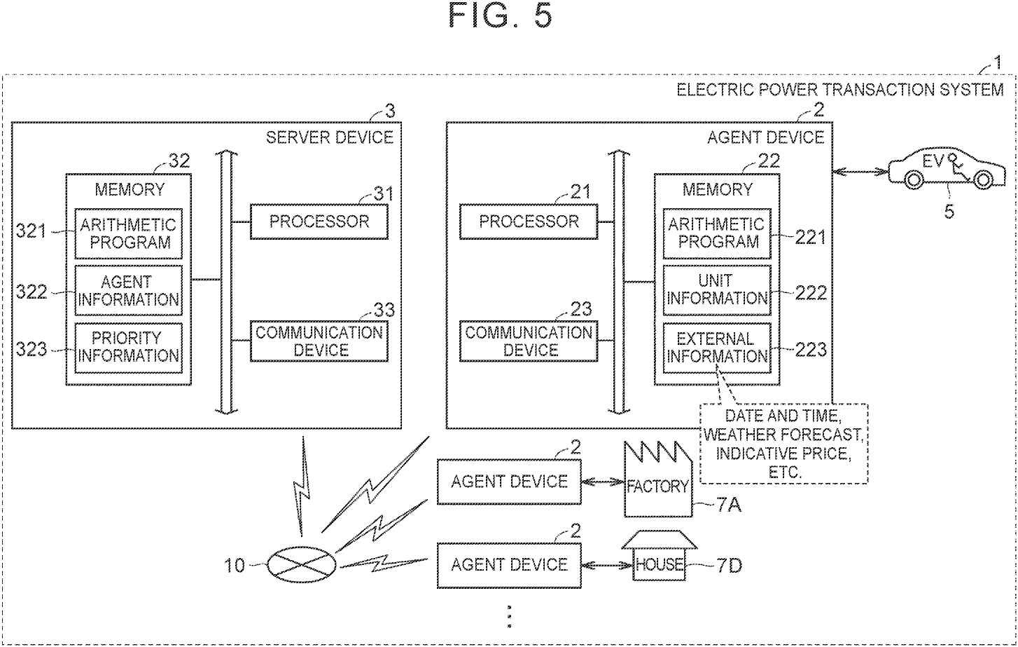

FIG. 5 is a diagram illustrating an example of a configuration of the electric power transaction system 1 according to the embodiment. As shown in FIG. 5, the electric power transaction system 1 includes the plurality of units, each of which can perform the electric power transfer, the agent devices 2, and the server device 3. In FIG. 5, the vehicle 5, the factory 7A, and the house 7D are exemplified as the units. The agent device 2 is connected to each unit.

The agent device 2 is connected to each of the units, and is configured to make a bid in the server device 3 regarding the electric power transaction of the connected unit. The agent device 2 includes a processor 21, a memory 22, and a communication device 23.

The processor 21 is an arithmetic unit (computer) that executes various processes by executing various programs. For example, the processor 21 is composed of a central processing unit (CPU), a field-programmable gate array (FPGA), a graphics processing unit (GPU), and the like. The processor 21 may be configured by processing circuitry.

The memory 22 stores programs and data for the processor 21 to execute various processes. For example, the memory 22 is composed of a storage medium such as a read only memory (ROM) and a random access memory (RAM). The memory 22 stores an arithmetic program 221 and unit information 222.

The arithmetic program 221 includes source codes for identifying a process to be executed by the processor 21. For example, the arithmetic program 221 includes source codes for bidding in the server device 3 regarding an electric power transaction of a unit connected to the agent device 2.

The unit information 222 includes information on a unit (for example, a vehicle 5) connected to the agent device 2, in particular information on bids and contracts of electric power transactions.

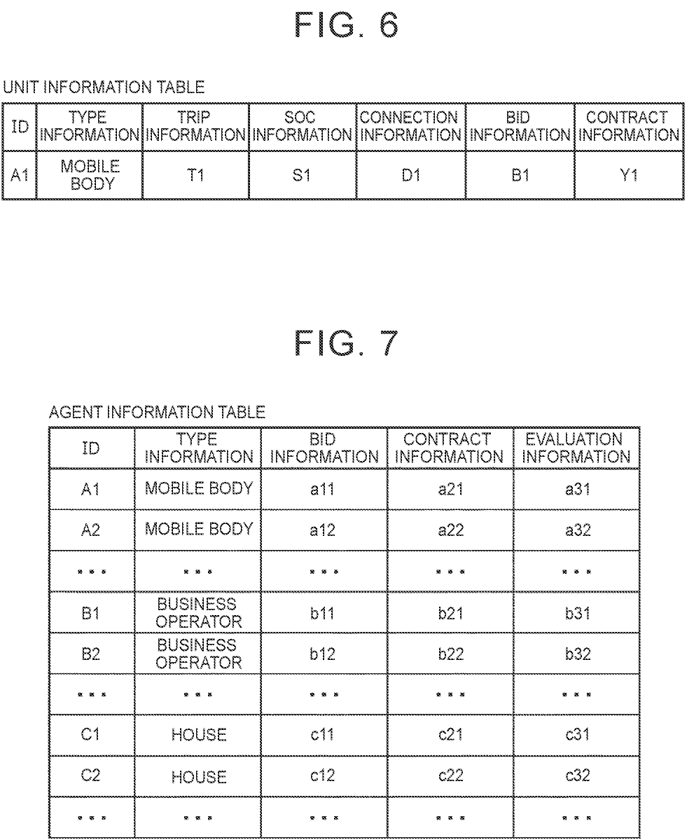

FIG. 6 is a diagram illustrating an example of the unit information 222 stored in the agent device 2. For example, the agent device 2 stores the unit information 222 in a table format as shown in FIG. 6. FIG. 6 shows a unit information table stored in the agent device 2 connected to the vehicle 5. As shown in FIG. 6, the unit information table includes ID, type information, trip information, state of charge (SOC) information, connection information, bid information, and contract information.

The ID includes identification information for identifying the unit (vehicle in this example). The type information includes information on the type of the unit, for example, information for identifying a mobile body (vehicle), a business operator, a house, and the like. The trip information includes information on the travel history such as the past travel route and the travel time. The SOC information includes information on the electric power amount currently stored in the battery. The connection information includes information for identifying whether the unit is currently connected to the charger/discharger. The bid information includes information on past bidding history and information on current bids. The contract information includes information on past contract history and information for identifying whether the current bid is contracted.

Returning to FIG. 5, the memory 22 further stores external information 223. The external information 223 includes information on the current date and time, information on weather forecasts, information on indicative prices of electric power prices in the electric power transaction market, and the like. The agent device 2 acquires these types of external information 223 from an external device such as the server device 3 via the network 10. In particular, since the indicative prices are managed and determined by the server device 3, the agent device 2 acquires the indicative prices from the server device 3.

The communication device 23 transmits/receives data to/from another agent device 2 or the server device 3 via the network 10 by wired communication or wireless communication.

The server device 3 is, for example, a device for managing electric power transactions in the general transaction market or the direct transaction market for the P2P electric power transactions, and executes processes related to electric power transactions. The server device 3 includes a processor 31, a memory 32, and a communication device 33.

The processor 31 is an arithmetic unit (computer) that executes various processes by executing various programs. The processor 31 is composed of, for example, a CPU, an FPGA, a GPU, and the like. The processor 31 may be configured by processing circuitry.

The memory 32 stores programs and data for the processor 31 to execute various processes. For example, the memory 32 is composed of a storage medium such as a ROM and a RAM. The memory 32 stores an arithmetic program 321 and agent information 322.

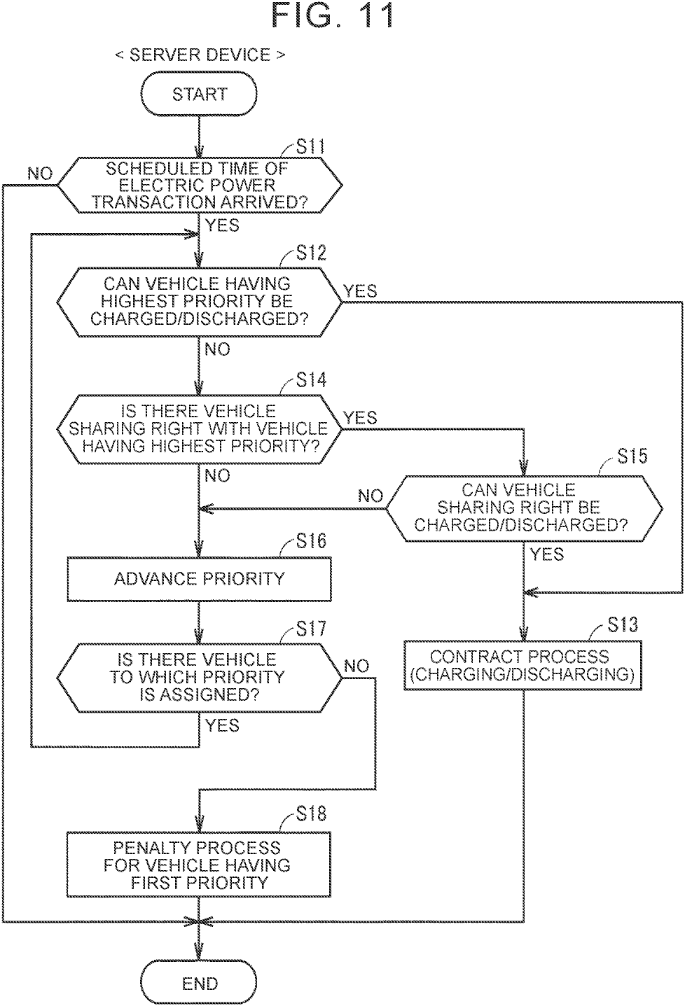

The arithmetic program 321 includes source codes for identifying a process to be executed by the processor 31. For example, the arithmetic program 321 includes source codes for executing the processes shown in FIGS. 10 and 11 described later.

The agent information 322 includes information on the agent device 2 participating in the electric power transaction market managed by the server device 3, in particular information on bids and contracts of electric power transactions.

FIG. 7 is a diagram illustrating an example of the agent information 322 stored in the server device 3. For example, the server device 3 stores the agent information 322 in a table format as shown in FIG. 7. As shown in FIG. 7, the agent information table includes ID, type information, bid information, contract information, and evaluation information.

The ID includes identification information for identifying the unit connected to each agent device 2. The type information includes information on the type of the unit, for example, information for identifying a mobile body (vehicle), a business operator, a house, and the like. The bid information includes information on past bidding history and information on current bids for each agent device 2. The contract information includes information on past contract history and information for identifying whether the current bid is contracted for each agent device 2. The evaluation information includes information on the evaluation result in past electric power transactions for each agent device 2. For example, the server device 3 adds evaluation points when the agent device 2 appropriately performed bids and contracts in past electric power transactions, and subtracts evaluation points when the agent device 2 canceled the electric power transfer even though the agent device 2 made a bid in past electric power transactions. The evaluation points calculated in this way are stored in the agent information table as the evaluation information.

Returning to FIG. 5, the communication device 33 transmits/receives data to/from the agent device 2 via the network 10 by wired communication or wireless communication.

In the electric power transaction system 1 configured as described above, the agent device 2 makes a bid for the electric power transaction in the server device 3 in the electric power transaction market based on the trip information, the SOC information, the connection information, and the like included in the unit information 222.

For example, the agent device 2 predicts the travel route of the vehicle 5, which is a unit, based on the trip information, and calculates the shortage of the electric power amount with respect to the current SOC among the electric power amount required to reach the target point. That is, the agent device 2 calculates the electric power amount that should be purchased in order to reach the target point in future traveling. The agent device 2 then presents the determined transaction price in order to purchase the calculated electric power amount, and bids for the electric power transaction in the server device 3 in the electric power transaction market. The bid information regarding the bid is transmitted from the agent device 2 to the server device 3. Since such bidding is performed by the agent device 2 corresponding to each of the units, the electric power amount and the transaction price are different for each of the units.

Further, the agent device 2 may bid for the electric power transaction in the server device 3 in the electric power transaction market based on the external information 223. For example, the agent device 2 may bid for an electric power transaction aiming at a unit time zone in which the price of the electric power amount is the lowest, based on the date and time and the indicative price. Further, the agent device 2 may calculate, based on the weather forecast, the electric power amount that can be generated by the vehicle 5 by the scheduled travel time or the electric power amount that can be generated by the vehicle 5 during traveling, and subtract the calculated electric power amount from the electric power amount that should be purchased in order to reach the target point.

When the server device 3 accepts a bid regarding an electric power transaction from the agent device 2, the server device 3 executes a process for scheduling the electric power transaction at the scheduled time and the charger/discharger designated by the agent device 2.

Then, at the arrival of the scheduled time, when the vehicle 5 is connected to the designated charger/discharger and the vehicle 5 can be charged/discharged via the charger/discharger, the server device 3 executes a contract process to contract the bid regarding the electric power transaction from the agent device 2. Accordingly, the electric power transfer is performed between the unit on the electric power supply side and the vehicle 5 via the charger/discharger.

On the other hand, at the arrival of the scheduled time, when the vehicle 5 cannot be charged/discharged via the charger/discharger, the server device 3 cancels the electric power transaction without contracting the bid regarding the electric power transaction from the agent device 2. In this case, since the unit on the electric power supply side cannot perform the scheduled electric power transaction, the server device 3 executes a penalty process for imposing a penalty on the user of the vehicle 5 that has caused the cancellation of the electric power transaction. For example, the server device 3 charges the user of the vehicle 5 for the canceled electric power transaction fee or the electric power transaction cancellation fee.

In this way, in the electric power transaction system 1, bids and contracts regarding electric power transactions are performed between the agent device 2 and the server device 3. However, the vehicle 5 is not always connected to the designated charger/discharger at the scheduled time after the agent device 2 bids for the electric power transaction. For example, the agent device 2 makes a bid by designating the time for the electric power transaction and the charger/discharger to be used for the electric power transaction based on the travel route predicted based on the trip information, regardless of the intention of the user of the vehicle 5. However, such predictions can be incorrect. In such a situation, imposing a penalty on the user of the vehicle 5 that caused the cancellation of the electric power transaction is disadvantageous to the user. In addition, the fact that the electric power transaction is not performed is disadvantageous to the unit on the electric power supply side.

Therefore, the electric power transaction system 1 according to the embodiment is configured to optimally perform the electric power transaction without interrupting the electric power transaction as much as possible.

Specifically, in the electric power transaction system 1, when the server device 3 accepts a bid from a plurality of agent devices 2 for electric power transactions to be performed through the same charger/discharger in the same electric power transaction time zone, the server device 3 determines the priority for contracting a bid for the electric power transaction. For example, as shown in FIG. 5, the memory 32 of the server device 3 stores priority information 323.

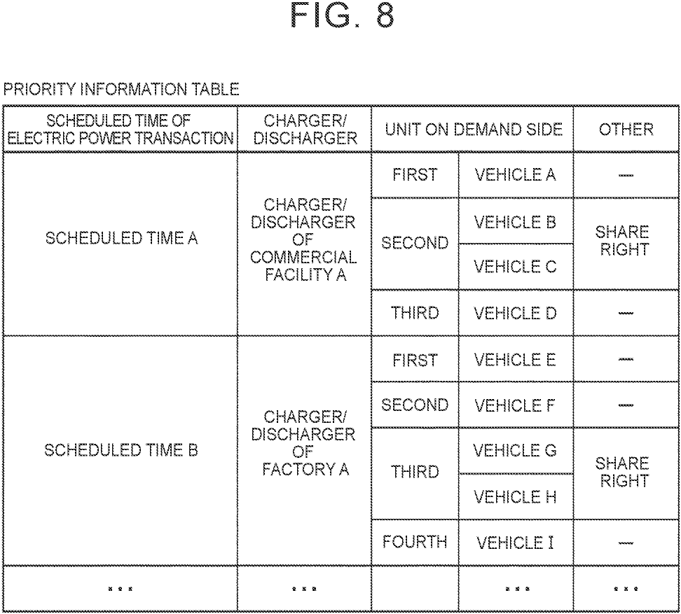

FIG. 8 is a diagram illustrating an example of the priority information 323 stored in the server device 3. For example, the server device 3 stores the priority information 323 in a table format as shown in FIG. 8. As shown in FIG. 8, a priority information table includes information for identifying the scheduled time of the electric power transaction, information for identifying the charger/discharger through which the electric power transaction is performed, information for identifying the unit on the demand side, and other information.

In the priority information 323, the priority (first, second, third, etc.) is set for a plurality of vehicles as units on the demand side. For example, for the electric power transaction to be performed using the charger/discharger of the commercial facility A at the scheduled time A, the server device 3 stores information for identifying the vehicle A as the first priority, information for identifying the vehicle B and the vehicle C as the second priority, and information for identifying the vehicle D as the third priority. A right for the electric power transaction is shared between the vehicle B and the vehicle C, and the server device 3 stores information indicating that the vehicle B and the vehicle C share the right.

For the electric power transaction to be performed using the charger/discharger of the factory A at the scheduled time B, the server device 3 stores information for identifying the vehicle E as the first priority, information for identifying the vehicle F as the second priority, information for identifying the vehicle G and the vehicle H as the third priority, and information for identifying the vehicle I as the fourth priority. The right for the electric power transaction is shared between the vehicle G and the vehicle H, and the server device 3 stores information indicating that the vehicle G and the vehicle H share the right.

At the arrival of the scheduled time of the electric power transaction, the server device 3 contracts the bid for the electric power transaction in descending order of priority (that is, in the order of first, second, third) according to the priority specified by the priority information 323. Accordingly, the server device 3 can optimally perform the electric power transaction without interrupting the electric power transaction between the units as much as possible.

### Example of Electric Power Transaction by Electric Power Transaction System

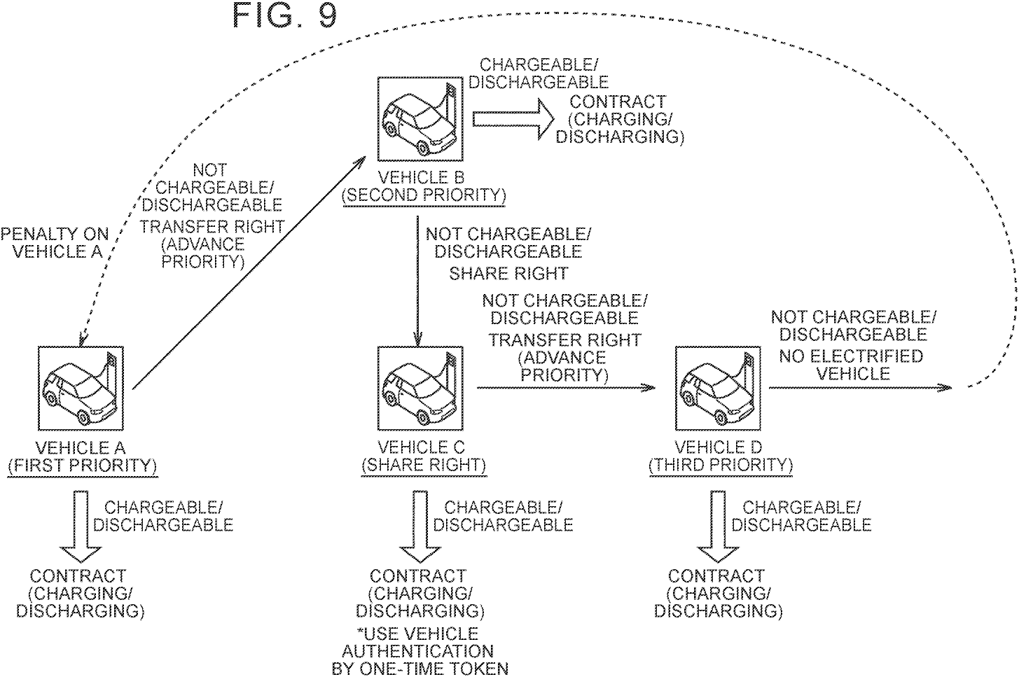

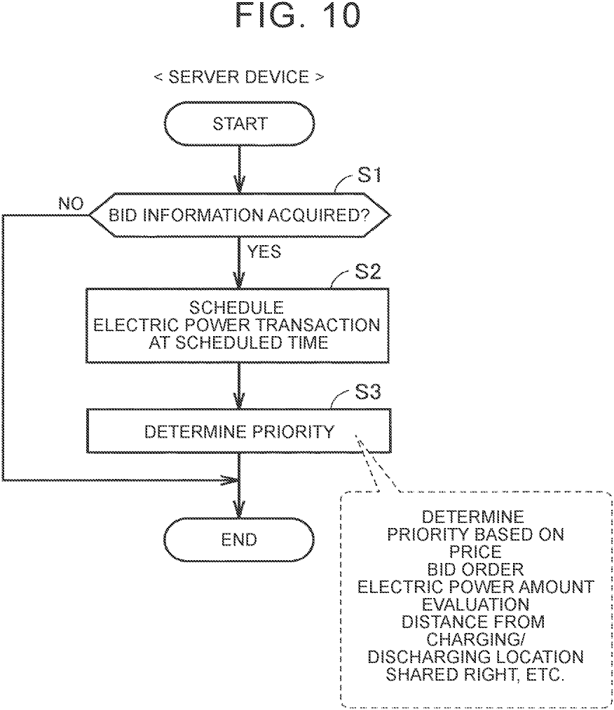

FIG. 9 is a diagram illustrating an example of an electric power transaction by the electric power transaction system 1. FIG. 9 shows an example of an electric power transaction performed using the charger/discharger of the commercial facility A stored in the priority table of FIG. 8.

As shown in FIG. 9, at the scheduled time (scheduled time A) of the electric power transaction, the server device 3 determines whether the vehicle A having the first priority can be charged/discharged by the charger/discharger of the commercial facility A. As examples of cases where charging/discharging cannot be performed, cases where the prediction of the user’s behavior (for example, the prediction of the travel route) by the agent device 2 is incorrect or the user fails to connect the vehicle to the charger/discharger are assumed. When the vehicle A can be charged/discharged by the charger/discharger of the commercial facility A, the server device 3 executes a contract process for performing the electric power transfer of the vehicle A to/from the charger/discharger of the commercial facility A. Accordingly, the battery of the vehicle A can be charged by receiving the electric power from the charger/discharger of the commercial facility A.

When the vehicle A cannot be charged/discharged by the charger/discharger of the commercial facility A at the scheduled time (scheduled time A), the server device 3 advances the priority and determines whether the vehicle B having the second priority can be charged/discharged by the charger/discharger of the commercial facility A. When the vehicle B can be charged/discharged by the charger/discharger of the commercial facility A, the server device 3 executes a contract process for performing the electric power transfer of the vehicle B to/from the charger/discharger of the commercial facility A. Accordingly, the battery of the vehicle B can be charged by receiving the electric power from the charger/discharger of the commercial facility A.

When the vehicle B cannot be charged/discharged by the charger/discharger of the commercial facility A at the scheduled time (scheduled time A), the server device 3 determines whether the vehicle C sharing the right with the vehicle B can be charged/discharged by the charger/discharger of the commercial facility A. When the vehicle C can be charged/discharged by the charger/discharger of the commercial facility A, the server device 3 executes a contract process for performing the electric power transfer of the vehicle C to/from the charger/discharger of the commercial facility A. Accordingly, the battery of the vehicle C can be charged by receiving the electric power from the charger/discharger of the commercial facility A.

Vehicle authentication for sharing the right may be performed between the vehicle B and the vehicle C. For example, when the user (manager) of the vehicle B and the user (manager) of the vehicle C are the same, the user (manager) can perform vehicle authentication between the vehicle B and the vehicle C in advance, so that when the electric power transaction cannot be performed for the vehicle B, the electric power transaction can be smoothly performed using the vehicle C instead of the vehicle B.

In the vehicle authentication, various authentication techniques can be used, such as, for example, sharing the same identification information (for example, a one-time token) between the vehicle B and the vehicle C. When the vehicle B cannot be charged/discharged by the charger/discharger of the commercial facility A, the server device 3 may perform the electric power transaction between the vehicle C, for which the vehicle authentication has been performed with the vehicle B, and the charger/discharger of the commercial facility A. Further, the identification information (for example, one-time token) may be used for authentication between each of the vehicle B and the vehicle C and the charger/discharger. In this case, when the vehicle B cannot be charged/discharged by the charger/discharger of the commercial facility A, the server device 3 may perform the electric power transaction between the vehicle C, for which the vehicle authentication has been performed with the charger/discharger of the commercial facility A, and the charger/discharger of the commercial facility A.

When the vehicle C cannot be charged/discharged by the charger/discharger of the commercial facility A at the scheduled time (scheduled time A), the server device 3 advances the priority and determines whether the vehicle D having the third priority can be charged/discharged by the charger/discharger of the commercial facility A. When the vehicle D can be charged/discharged by the charger/discharger of the commercial facility A, the server device 3 executes a contract process for performing the electric power transfer of the vehicle D to/from the charger/discharger of the commercial facility A. Accordingly, the battery of the vehicle D can be charged by receiving the electric power from the charger/discharger of the commercial facility A.

When the vehicle D cannot be charged/discharged by the charger/discharger of the commercial facility A at the scheduled time (scheduled time A), the server device 3 executes a penalty process for imposing a penalty on the user of the vehicle A having the first priority because there is no vehicle that is bidding for the electric power transaction.

In the above-mentioned example of FIG. 9, the commercial facility A or the charger/discharger of the commercial facility A (that is, the unit on the electric power supply side) is an example of the “first unit”. The vehicle A (that is, the unit having the first priority) is an example of the “second unit”. Each of the vehicle B, the vehicle C, and the vehicle D (that is, the unit having the second priority or lower) is an example of the “third unit”.

### Process of Server Device at Time of Bidding

FIG. 10 is a flowchart showing a process procedure at the time of bidding in the server device 3. The flowchart of FIG. 10 is called from a main routine (not shown) and executed periodically when, for example, a predetermined condition is satisfied. Each step is realized as the processor 31 of the server device 3 executes the arithmetic program 321. Hereinafter, the step is abbreviated as S.

As shown in FIG. 10, the server device 3 acquires the bid information to determine whether a bid regarding an electric power transaction from the agent device 2 has been accepted (S1). The bid information includes, for example, information such as the scheduled time of the electric power transaction, the location of the electric power transaction (location of the charger/discharger or the like), the transaction price, and the electric power amount to be transacted.

When the server device 3 has not acquired the bid information (NO in S1), the server device 3 returns the process to the main routine. On the other hand, when the server device 3 has accepted the bid regarding the electric power transaction from the agent device 2 by acquiring the bid information (YES in S1), the server device 3 executes a process for scheduling the electric power transaction at the scheduled time and the charger/discharger designated by the agent device 2 (S2). For example, as the bid information included in the agent information 322 of FIG. 7 stored in the memory 32, the server device 3 stores flag information for executing the electric power transaction at the scheduled time, and stores the location information of the charger/discharger by which the electric power transaction is scheduled to be performed.

Next, the server device 3 determines the priority before the scheduled time of the electric power transaction arrives (S3). For example, as the priority information 323 of FIG. 8 stored in the memory 32, the server device 3 determines the priority according to predetermined rules for the plurality of the vehicles corresponding to each of a plurality of the agent devices 2 that has bidden for the electric power transaction by the same charger/discharger in the same electric power transaction time zone.

For example, the server device 3 determines, as predetermined rules, the priority based on at least one of the transaction price of the electric power transfer, the bid order for the electric power transaction, the electric power amount for the electric power transaction, the past evaluation result for the electric power transaction, the distance from the location of the charger/discharger in which the electric power transaction is performed, and the supply of rights for the electric power transaction.

Specifically, the server device 3 may set, of the vehicles for which bids have been made, a higher priority from the highest transaction price of the electric power transfer. The server device 3 may set, of the vehicles for which bids have been made, a higher priority from the earliest bid timing. The server device 3 may set, of the vehicles for which bids have been made, a higher priority from the largest electric power amount in the electric power transaction. The server device 3 may set, of the vehicles for which bids have been made, a higher priority from the highest past evaluation result in the electric power transaction. The server device 3 may specify the evaluation result based on the evaluation information included in the agent information 322 of FIG. 7 stored in the memory 32. The server device 3 may set, of the vehicles for which bids have been made, a higher priority from the shortest distance between the vehicle and the location of the charger/discharger by which the electric power transaction is performed. Further, the server device 3 may determine the priority using only one rule among the plurality of types of rules as described above, or may determine the priority by combining a plurality of rules. That is, the server device 3 can determine the priority based on at least one of the plurality of types of rules as described above.

After S3, the server device 3 returns the process to the main routine and suspends the contract until the scheduled time of the electric power transaction arrives.

### Process of Server Device at Time of Electric Power Transaction

FIG. 11 is a flowchart showing a process procedure at the time of the electric power transaction in the server device 3. The flowchart of FIG. 11 is called from a main routine (not shown) and executed periodically when, for example, a predetermined condition is satisfied. Each step is realized as the processor 31 of the server device 3 executes the arithmetic program 321. Hereinafter, the step is abbreviated as S.

As shown in FIG. 11, the server device 3 determines whether the scheduled time of the electric power transaction has arrived (S11). When the scheduled time of the electric power transaction has not arrived (NO in S11), the server device 3 returns the process to the main routine.

On the other hand, when the scheduled time of the electric power transaction has arrived (YES in S11), the server device 3 determines whether the vehicle having the highest priority can be charged/discharged (S12). When the vehicle having the highest priority can be charged/discharged (YES in S12), the server device 3 executes a contract process for the vehicle having the highest priority to perform an electric power transaction (S13). For example, by executing the contract process, the server device 3 transmits a control signal for performing the electric power transfer for each of the unit on the electric power supply side and the vehicle having the highest priority. After that, the server device 3 returns the process to the main routine.

On the other hand, when the vehicle having the highest priority cannot be charged/discharged (NO in S12), the server device 3 determines whether there is a vehicle sharing the right with the vehicle having the highest priority (S14). When there is a vehicle sharing the right with the vehicle having the highest priority (YES in S14), the server device 3 determines whether the vehicle sharing the right can be charged/discharged (S15). When the vehicle sharing the right can be charged/discharged (YES in S15), the server device 3 executes a contract process for the vehicle sharing the right to perform the electric power transaction (S13). For example, by executing the contract process, the server device 3 transmits a control signal for performing the electric power transfer to each of the unit on the electric power supply side and the vehicle sharing the right. After that, the server device 3 returns the process to the main routine.

On the other hand, when there is no vehicle sharing the right with the vehicle having the highest priority (NO in S14), the server device 3 advances the priority (S16). Subsequently, the server device 3 determines whether there is a vehicle to which the priority is assigned (S17). When there is a vehicle to which the priority is assigned (YES in S17), the server device 3 returns to S12 and determines again whether the vehicle having the highest priority can be charged/discharged.

On the other hand, when there is no vehicle to which the priority is assigned (NO in S17), the server device 3 executes the penalty process for the vehicle having the first priority (S18). For example, the server device 3 executes a process for charging the user of the vehicle having the first priority for the canceled electric power transaction fee or the electric power transaction cancellation fee. After that, the server device 3 returns the process to the main routine.

As described above, with the electric power transaction system 1 according to the present embodiment, after the bid regarding the electric power transaction of the unit having the first priority (the vehicle in this example) with the unit on the electric power supply side is accepted, even when the electric power transfer with the unit on the electric power supply side is not performed by the unit having the first priority at the scheduled time of the electric power transfer, the unit having the second priority or lower performs the electric power transfer with the unit on the electric power supply side. As a result, the electric power transaction can be optimally performed without interrupting the electric power transaction between the units as much as possible.

When the electric power transfer is not performed with the unit on the electric power supply side at the scheduled time of the electric power transfer, a penalty is imposed on the user of the unit having the first priority. However, since the unit having the second priority or lower, instead of the unit having the first priority, performs the electric power transfer with the unit on the electric power supply side, it is possible to avoid imposing a penalty on the user of the unit having the first priority.

When the electric power transfer with the unit on the electric power supply side is not performed by the unit having the first priority at the scheduled time of the electric power transfer, the unit to perform the electric power transaction is determined according to the priority based on the predetermined rules, so that the electric power transaction is optimally performed according to the priority.

Since the priority for determining the unit having the second priority or lower is determined before the scheduled time of the electric power transfer arrives, the electric power transaction is optimally performed according to the predetermined priority.

The transaction for the electric power transfer is optimally performed according to the priority determined based on at least one of the transaction price of the electric power transfer, the bid order for the transaction of the electric power transfer, the electric power amount for the transaction of the electric power transfer, the past evaluation result for the transaction of the electric power transfer, and the distance from the location in which electric power transfer is performed.

Even when the electric power transfer with the unit on the electric power supply side is not performed by the unit having the first priority at the scheduled time of the electric power transfer, a unit sharing the right with the unit having the first priority performs the electric power transfer with the unit on the electric power supply side, so that the transaction for the electric power transfer is optimally performed.

### Modification

The present disclosure is not limited to the above-described embodiment, and various modifications and applications can be carried out. Hereinafter, modifications applicable to the present disclosure will be described.

In the above-described embodiment, the agent device 2 makes a bid for the electric power transaction in the server device 3 regardless of the intention of the user of the unit (for example, the vehicle). However, the user himself/herself may make a bid for the electric power transaction in the server device 3. For example, the agent device 2 may be an information terminal device that allows the user to operate for bidding. The information terminal device may be, for example, a personal computer (PC), a navigation system mounted on a vehicle, and a mobile terminal such as a smartphone.

Further, the server device 3 may perform bids and contracts of electric power transactions for units participating in the electric power transaction market.

In the above-described embodiment, the server device 3 allows the unit determined according to the priority to perform the electric power transfer, but the server device 3 may allow a unit selected by the user of the unit having the first priority to perform the electric power transfer. For example, in the example of FIG. 9, the electric power transaction system 1 may be configured so as to allow the user of the vehicle A having the first priority to select the vehicle having the second priority or lower before the scheduled time of the electric power transfer arrives.

In other words, the processor 31 of the server device 3 may determine the unit selected by the user of the unit having the first priority as the unit having the second priority or lower before the scheduled time arrives. In this way, even when the electric power transfer with the unit on the electric power supply side is not performed by the unit having the first priority at the scheduled time of the electric power transfer, the unit having the second priority or lower that has been selected by the user of the unit having the first priority performs the electric power transfer with the unit on the electric power supply side, so that the electric power transaction is optimally performed.

In the above-described embodiment, as an example of the case where the unit having the first priority does not perform the electric power transfer with the unit on the electric power supply side at the scheduled time of the electric power transfer, a case where the prediction of the user’s behavior (for example, the prediction of the travel route) by the agent device 2 is incorrect has been described. However, the processor 31 of the server device 3 may execute the contract process when the user of the unit having the first priority cancels the electric power transfer with the unit on the electric power supply side at the scheduled time of the electric power transfer. In this way, even when the electric power transfer with the unit on the electric power supply side is canceled by the user of the unit having the first priority at the scheduled time of the electric power transfer, the unit having the second priority or lower performs the electric power transfer with the unit on the electric power supply side, so that the electric power transaction is optimally performed.

In the above-described embodiment, the unit on the electric power supply side is exemplified as the “first unit”, the unit having the first priority on the electric power receiving side is exemplified as the “second unit”, and the unit having the second priority or lower on the electric power receiving side is exemplified as the “third unit”. However, the “first unit” may be the unit on the electric power receiving side, the “second unit” may be the unit having the first priority on the electric power supply side, and the “third unit” may be the unit having the second priority or lower on the electric power supply side. In other words, the electric power transaction system 1 may be applied to an example in which each of the plurality of agent devices 2 wishing to sell electric power makes a bid in the server device 3 for the agent device 2 wishing to purchase the electric power. In this case, after the bid regarding the electric power transaction of the unit on the electric power supply side having the first priority for the unit on the electric power receiving side is accepted, even when the electric power transfer with the unit on the electric power receiving side is not performed by the unit on the electric power supply side having the first priority at the scheduled time of the electric power transfer, the unit on the electric power supply side having the second priority or lower performs the electric power transfer with the unit on the electric power receiving side. As a result, the electric power transaction can be optimally performed without interrupting the electric power transaction between the units as much as possible.

In the above-described embodiment, the vehicle is exemplified as the “first unit”, the “second unit”, and the “third unit”. However, each of the “first unit”, the “second unit”, and the “third unit” is not limited to a vehicle, and may be various buildings such as factories, companies, commercial facilities, houses, and stores as shown in FIG. 1 or a charger/discharger connected to these buildings.

The embodiment disclosed herein should be considered to be exemplary and not restrictive in all respects. The scope of the present disclosure is shown by the scope of claims rather than the description of the embodiment above, and is intended to include all modifications within the meaning and the scope equivalent to the scope of claims.

What is claimed is:

1. A server device that performs a transaction for electric power transfer between a plurality of units, the server device comprising:
a processor; and
a memory that stores a program executed by the processor, wherein:
the units include a first unit, a second unit, and a third unit; and
the processor
accepts a bid of the second unit regarding the transaction for the electric power transfer with the first unit, and
executes a contract process for causing the third unit to perform the electric power transfer with the first unit, when the second unit does not perform the electric power transfer with the first unit at a scheduled time of the electric power transfer.

2. The server device according to claim 1, wherein the processor executes a penalty process for imposing a penalty on a user of the second unit, when the second unit does not perform the electric power transfer with the first unit at the scheduled time.

3. The server device according to claim 1, wherein the processor determines the third unit from the units according to a priority based on a predetermined rule, when the second unit does not perform the electric power transfer with the first unit at the scheduled time of the electric power transfer.

4. The server device according to claim 3, wherein the processor determines the priority before the scheduled time arrives.

5. The server device according to claim 3, wherein the processor determines, as the predetermined rule, the priority based on at least one of a transaction price of the electric power transfer, a bid order for the transaction of the electric power transfer, an electric power amount for the transaction of the electric power transfer, a past evaluation result for the transaction of the electric power transfer, and a distance from a location in which the electric power transfer is performed.

6. The server device according to claim 1, wherein the processor determines a unit that shares a right with the second unit as the third unit.

7. The server device according to claim 1, wherein the processor determines a unit selected by a user of the second unit as the third unit before the scheduled time arrives.

8. The server device according to claim 1, wherein the processor executes the contract process when a user of the second unit cancels the electric power transfer with the first unit at the scheduled time.

9. An electric power transaction system that performs a transaction for electric power transfer, the electric power transaction system comprising:
a plurality of units, each of which is able to perform the electric power transfer; and
a server device, wherein:
the units include a first unit, a second unit, and a third unit; and
the server device
accepts a bid of the second unit regarding the transaction for the electric power transfer with the first unit, and
executes a contract process for causing the third unit to perform the electric power transfer with the first unit, when the second unit does not perform the electric power transfer with the first unit at a scheduled time of the electric power transfer.
